(19) United States
(12) Patent Application Publication
(10) Pub. No.: US 2015/0319946 A1
(43) Pub. Date: Nov. 12, 2015

(54) Hydroponic Growing Pot with Integrated Plant Support and Method for Growing Supported Hydroponic Plants.

(71) Applicant: Jason Center, Birmingham, AL (US)

(72) Inventor: Jason Center, Birmingham, AL (US)

(21) Appl. No.: 14/273,301

(22) Filed: May 8, 2014

(51) Int. Cl. A01G 31/02

(52) U.S. Cl. CPC A01G 31/02

(57) ABSTRACT

A hydroponic growing pot with an integrated plant support that is removable and also a method of the hydroponic growing of a plant with permanent stability for the life of the plant. Specifically, a hydroponic growing pot intended to hold a growing medium substrate and having apertures for liquid communication in its sidewall and bottom and rim located on its upper edge. The rim allows the pot to be lowered into a liquid holding reservoir and suspended on the top of the reservoir. The pot has an elevated mount adapted to receive a plant support holder in rigid and locked connection, the plant support holder with a base portion and a stalk portion. The plant support holder has a hollow channel that runs through the length of the stalk portion and the base portion for the insertion of a plant support to be attached to a plant.

### FIELD OF THE INVENTION

The present invention relates to horticulture in general and more specifically to the growth of plants by way of hydroponic methods and the support of such plants using hydroponic pots with integrated plant support.

### BACKGROUND OF THE INVENTION

There are many hydroponic systems, methods and associated hardware in use today. Generally, hydroponics involves the use of a mineral nutrient solution in water without the use of soil. There are two types of hydroponic growing methods. One method is using water only to deliver nutrients to plants—this method is termed solution culture. The second method is using a solid medium in conjunction with water to deliver nutrients to plants—this method is termed medium culture. The present invention relates to the growing of plants using medium culture. Medium culture uses various types of substrate mediums such as expanded clay aggregate, perlite, pumice, small rocks, and various other type of medium. The medium substrate has qualities that allow it to retain air and/or moisture and also has surface features that allow a plant root to attach thereto. Generally, medium culture requires a nutrient reservoir that can be of many different sizes, shapes and configurations. Common household buckets serve this purpose quite frequently. In addition to the reservoir, a growing pot is used to contain the medium and allow the plants roots to take hold therein. The growing pot can be used to grow more than one plant. In use, the growing pot is placed into the nutrient rich reservoir with its rim coming to rest on the top edge of the reservoir so that the growing pot is suspended in the nutrient solution.

The growing pot contains a plurality of apertures that allow the travel of water and nutrients through them and into the medium where the plant roots take hold. As the plants use the nutrients in the solution directly in the vicinity of the roots, nutrients flow towards the plant roots so as to maintain equilibrium in solution. During the lifecycle of the plant, the nutrient rich water will be depleted of its mineral nutrients as well as its oxygen. As a result, the growing pot must be lifted out of the reservoir so as to either replace the nutrient solution or place the growing pot and plant into a different reservoir with fresh nutrient solution.

Due to the physical characteristics of hydroponic substrate medium, it is a poor anchor for plant supports and thus creates problematic results. This is further enhanced by the some of the side effects of hydroponic plant growth such as smaller stems and larger fruit which in turn lead to a less stable plant. Specifically, the substrate medium is by design not compact enough and does not provide the appropriate amount of horizontal rigidity as does soil. When a user inserts a vertical plant support member into the substrate medium, it cannot maintain a rigid position because the substrate medium is easily moved. This is especially enhanced when a plant and its weight is attached to a vertical plant support member. This inability to maintain rigid position is further exhibited when a user attempts to move the growing pot out of the reservoir for replacement of the nutrient solution with said plant attached to the plant support road. The vertical plant support member fails and becomes disengaged from the substrate medium. Because a plant depletes the nutrients and oxygen in the water as it grows, the solution in the reservoir must be changed frequently during a plant's life thereby requiring plant support during the change.

While plant supports exist in the prior art for individual reservoir and growing pot hydroponic techniques, they are inadequate for keeping a plant supported at all times. There exist inadequate plant support members that are attached to the outside surface of the reservoir providing a support member for the plant. However, when a user proceeds to remove the growing pot from the reservoir the plant support member has to be disengaged. This causes the plant to fall upon itself damaging fruit and the plant itself. Plants which have depended on supplemental support in their growth cycle will fail when that same support is removed. A further problem with this type of support system is that it is susceptible to outside forces that would disengage it from a plant. One example is an accidental disengagement by the inadvertent contact by a user with the plant support on the outside of the reservoir.

Another system, as described in International Application No. WO 2009/070214A1, utilizes a basket type apparatus that is embedded into the medium substrate with multiple support members extending in different directions around the pot. This type of support apparatus is subject to being disengaged from the medium substrate because it only relies on the weight of medium substrate to keep it in fixed position. Medium substrate is commonly very light weight and does not exert sufficient lateral and downward pressure on a plant support to keep it in place. Another problem that arises with this type of plant support is that of plant growth direction. If a plant fails to grow evenly in all directions with its associated fruit and foliage, and only grows in a particular direction, then the support apparatus can be pulled to one side and fail causing the plant to fall.

What is needed in the art is a rigid and centrally located plant support that can be used with a growing pot regardless of the type substrate medium chosen. It is an object of the present invention to provide a hydroponic growing pot with an integrated plant support holder and inserted plant support that will provide the appropriate rigidity required by plants, that will allow a user to remove a hydroponic growing pot without disengagement of the plant support member with the plant, and to alternatively have the option of uninstalling the plant support member and holder if a user desires to grow plants without the presence of the plant support member and holder. It is a further object of the invention to provide a hydroponic growing pot with an integrated plant support holder that has low production costs and is also stackable and suited for bulk shipping.

### SUMMARY OF THE INVENTION

The above objectives are accomplished according to the present invention by providing a novel hydroponic growing pot and method as described below. In a preferred embodiment there is provided a hydroponic growing pot comprising a bottom, a sidewall, a top edge, a plurality of apertures located in said bottom and said sidewall for water communication with a liquid reservoir and the growth medium, and a rim located on the top edge of the sidewall. The present invention further comprises an integrated plant support holder that is adapted to be installed onto the bottom of the hydroponic growing pot. The plant support holder has a base portion and a stalk portion with a hollow channel running through the length of the base and stalk portions. The hollow channel tapers from a larger diameter at the top of the stalk portion to a narrower diameter at its bottom near the base of said plant support holder. This taper allows for a plant support to nest against the hollow channel and on top of a solid surface.

The plant support holder and the bottom surface of the hydroponic growing pot comprise means of joining the two together such that they are joined in rigid connection while installed but may be removed as well. The means on the bottom surface of the hydroponic growing pot is an elevated mount with a plurality of locking tabs located on the periphery of its outer edge. In a preferred embodiment the elevated mount is circular with a substantially solid central top surface and rises a height off of the upper surface of the bottom of the hydroponic growing pot, but it could be of any variety of shapes such as rectangular or triangular. The means for rigid connection located on the plant support holder are slots formed in the base portion of the plant support holder for receiving locking tabs located on the elevated mount. The underside of the the base of the plant support holder is the female counterpart to that of the elevated mount so that there is made a snug connection. The plant support holder by way of its base portion fits snugly on top of the elevated mount. This snug fit gives the plant support holder rigidity. Further, the plant support holder base slots provide the final measure of rigidity by allowing the locking tabs located on the elevated mount to move through the slots and lock onto the top of the base portion of the plant support holder.

The locking tabs have a protruded lip that is located on their upper and outer edge. The locking tabs, as well as the hydroponic growing pot, are made of ABS plastic and have a measure of flexibility. They flex when pressure is applied to them, but when pressure is taken away they return quickly and rigidly to their initial position. It is this inherent ability for the locking tabs to return to position which allows them to lock onto the base portion of the plant support holder. The slots are situated on the base portion of the plant support holder such that the protruding lips of the locking tabs extend beyond the slots outer periphery but the locking tab bases align exactly. In installation, the locking tabs are flexed an adequate distance inward to allow the protruding lips to clear the slots and allow the locking tabs to return to their original fixed position once the protruding lips are in communication with the top surface of the base portion of the plant support holder. In another embodiment, the plant support holder and the elevated mount on the bottom surface of the hydroponic pot can have corresponding threads as a means for attachment. In a further embodiment, the elevated mount and plant support holder base can be formed to such tolerances that the installation of the plant support holder onto the elevated mount will maintain rigid connection due to a very tight fit and the frictional properties of the ABS plastic surfaces when in tight connection.

The elevated mount is substantially solid on its upper surface in its center region to provide a resting place for the installed central plant support. The central plant support can be formed of most any rigid material such as wood, metal, fiberglass, graphite and rigid plastic, but it is generally shaped as a straight rod with a diameter that allows vertical installation and nesting into the hollow channel of the plant support holder. A plant can then be attached to the central plant support at any point along its length with various types of attachment means such as tape, string, zip-ties, flexible rubber or plastic, rubber bands. The central plant support can also be formed to be multi-segmented so that segments can be installed according to the growth stage and a plant's height. The plant support segments can be joined by means of threaded engagement. Each plant support segment would have on one end a threaded male section and a female threaded section on its other end. This would allow a user to use as many segments as needed to achieve a given height. The plant support segments can also be joined by way of a plant support segment having a male ferrule on one end and a female ferrule on the other end such that each plant support segment can be joined to another. In addition to the central plant support, horizontal plant supports can be attached to the central plant support to provide further options in supporting a plant. The horizontal plant supports can be attached to the central plant supports by using string, tape, rubber strips and/or wire or other similar materials.

In a preferred embodiment, the hydroponic growing pot and the plant support holder are formed through the process of injection molding.

### BRIEF DESCRIPTION OF THE DRAWINGS

The present invention can be best understood in connection with the accompanying drawings. It is noted that the invention is not limited to the precise embodiments shown in the drawings, in which:

FIG. 1 is a side elevation of the hydroponic growing pot.

FIG. 2 is top plan view of the hydroponic growing pot.

FIG. 3 is a bottom plan view of the hydroponic pot.

FIG. 4 is a cross section of the hydroponic growing pot along the plane A-A.

FIG. 5 is a perspective view of the hydroponic growing pot.

FIG. 6 is a side elevation of the plant support holder.

FIG. 7 is a perspective view of the plant support holder.

FIG. 8 is a cross-section view of the plant support holder.

FIG. 9 is a top plan view of the plant support holder.

FIG. 10 is bottom plan view of the plant support holder.

FIG. 11 is an exploded side elevation of the elevated mount.

FIG. 12 is exploded top plan view of the elevated mount.

FIG. 13 is a perspective view of the plant support holder installation onto the elevated mount.

FIG. 14 is an exploded side elevation of the plant support holder installed on the elevated mount.

FIG. 15 is a perspective view of the hydroponic growing pot being placed into a reservoir.

FIG. 16 is a perspective view of plant support segments joined by male and female ferrules.

FIG. 17 is a perspective view of plant support segments joined by male and female threads.

### DETAILED DESCRIPTION OF THE PREFERRED EMBODIMENTS

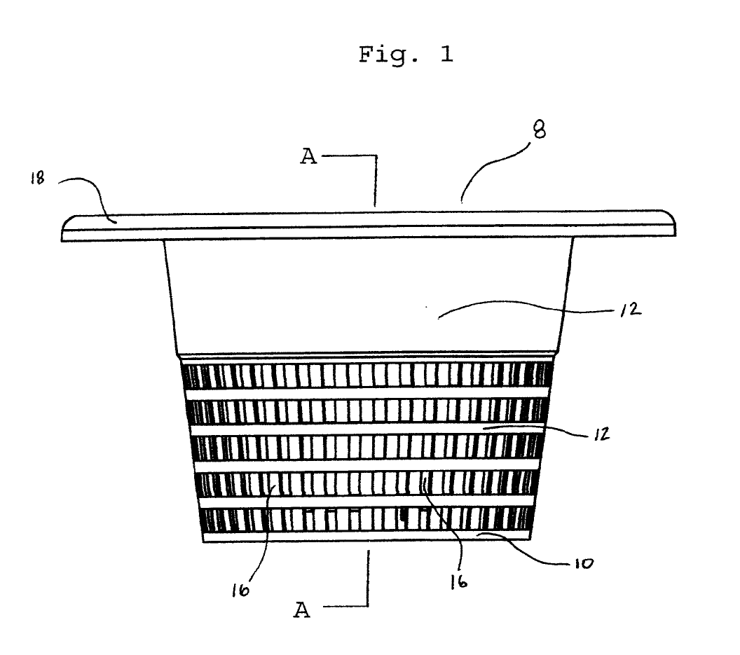

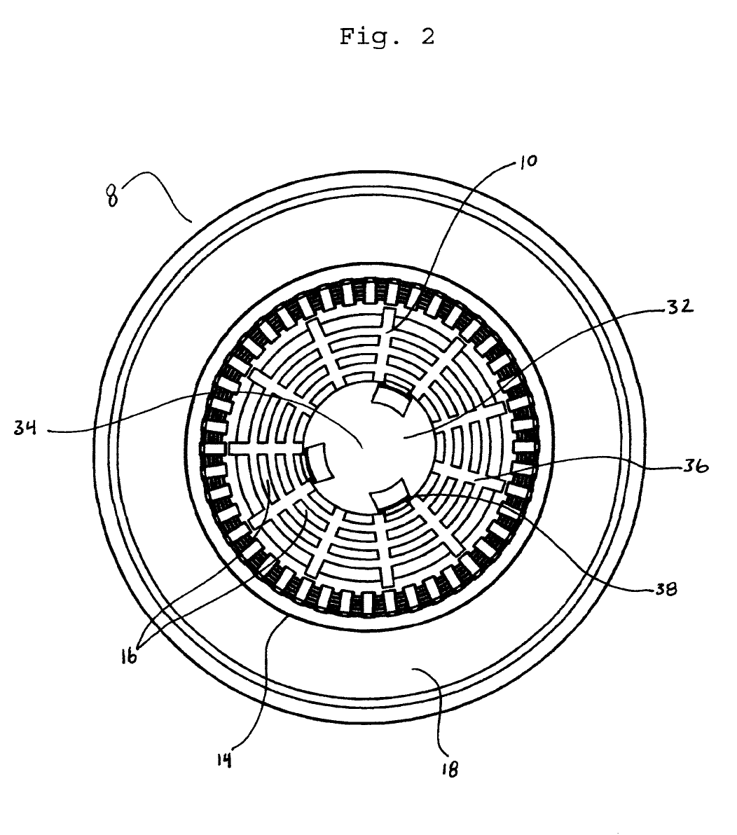

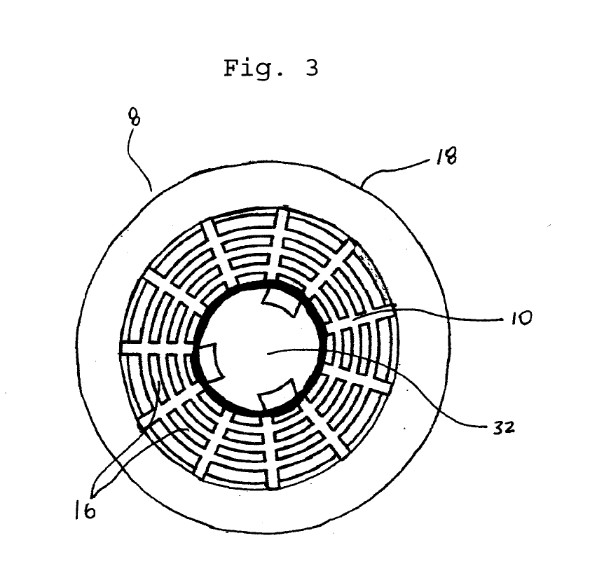

FIG. 1 shows a hydroponic growing pot 8 including a bottom 10, a sidewall 12, apertures 16 in the sidewall 12 and a rim 18. The apertures 16 are located uniformly along the sidewall and bottom 10 and allow the communication of liquid into and out of the pot 8. FIG. 2 shows a top edge 14, an elevated mount 32, the upper surface 36 of the bottom 10 of the growing pot 8 and locking tab 38. The elevated mount 32 has a substantially solid central top surface 34 and is circular around its perimeter. In addition, FIG. 2 and FIG. 3 depict apertures 16 in the bottom 10 of the pot 8 for liquid communication. The hydroponic growing pot 8 and plant support holder 20 are formed by the process of injection molding and is made of ABS plastic and are shaped to be stackable for bulk transport.

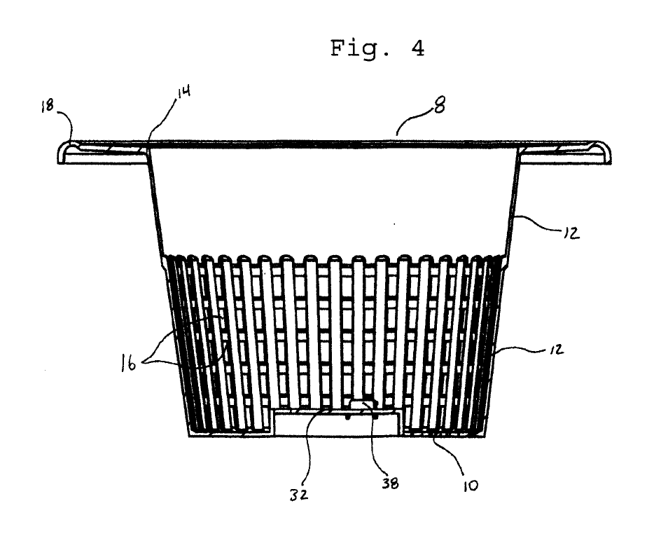

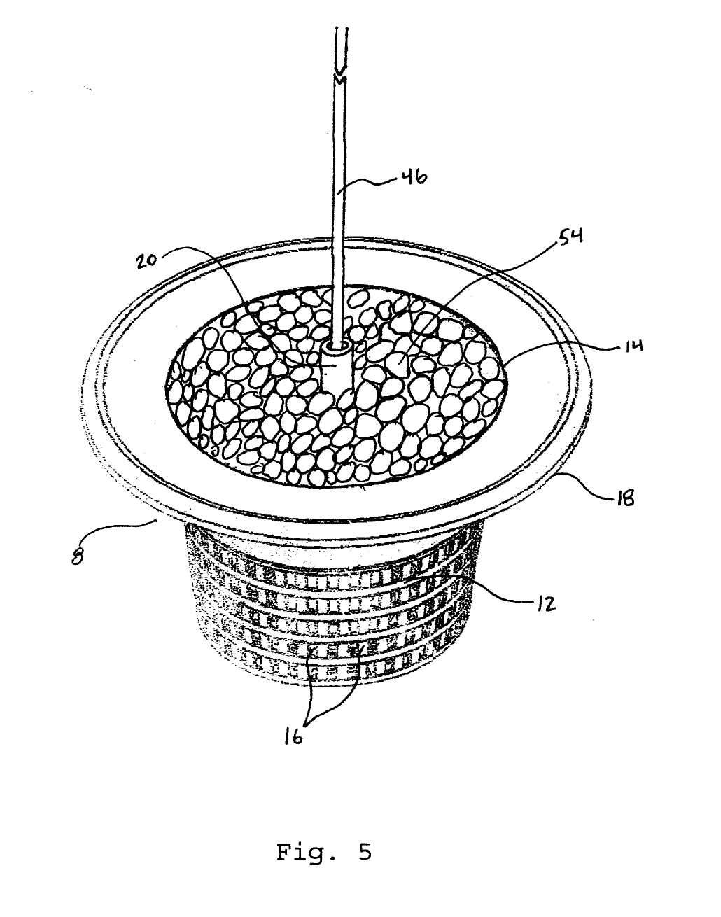

FIG. 4 shows the elevated mount 32 extending upwards from the bottom 10. Also shown is a locking tab 38 located on the top outer edge 44 of the elevated mount 32. Further shown is where the rim 18 meets the top edge 14 of the sidewall 12. FIG. 5 shows the hydroponic growing pot 8 with an installed plant support holder 20, a central plant support 46 installed within the plant support holder 20, and the hydroponic growing pot 8 filled with a substrate medium 54.

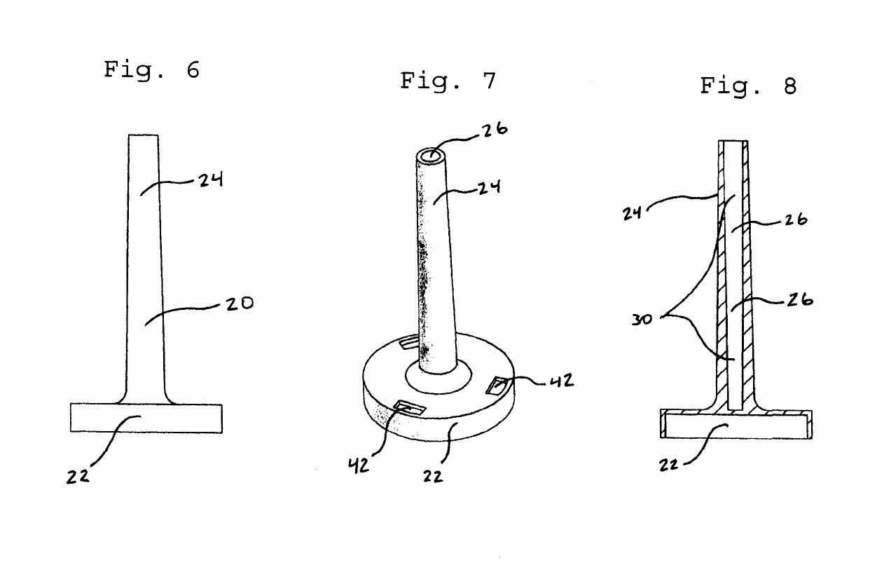

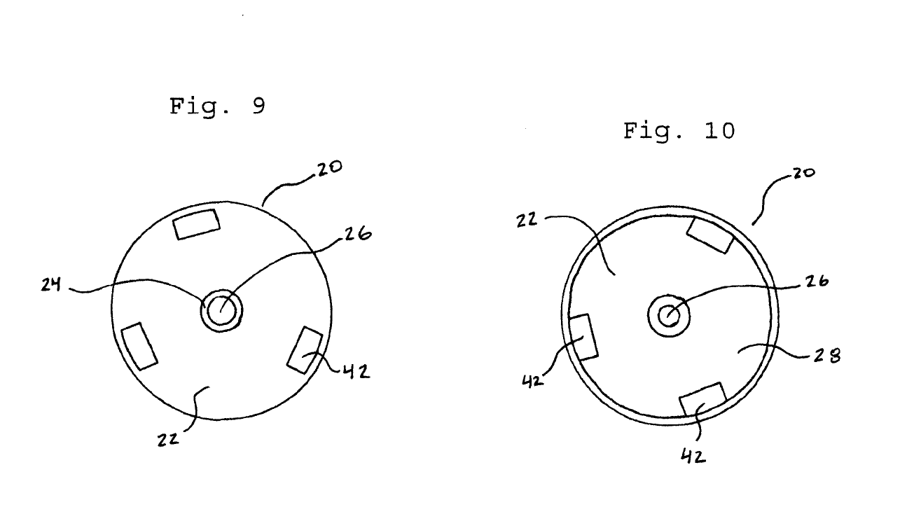

FIGS. 6-10 depict the plant support holder 20 with a stalk portion 24, a base portion 22, a hollow channel 26 running through the stalk portion 24 and the base portion 22. As shown in FIG. 9, the hollow channel 26 has a taper 30 whereby the diameter of the hollow channel 26 is wider at the top of the stalk portion 24 and narrower near the base portion 22. In addition, slots 42 are located on the top of the base portion 22 of the plant support holder 20. The bottom underside 28 of the plant support holder 20 base portion 22 is formed to fit on top of the elevated mount 32 just as the elevated mount 32 is formed to be of the corresponding height to fully occupy the bottom underside 28 of the base portion 22 of the plant support holder 20.

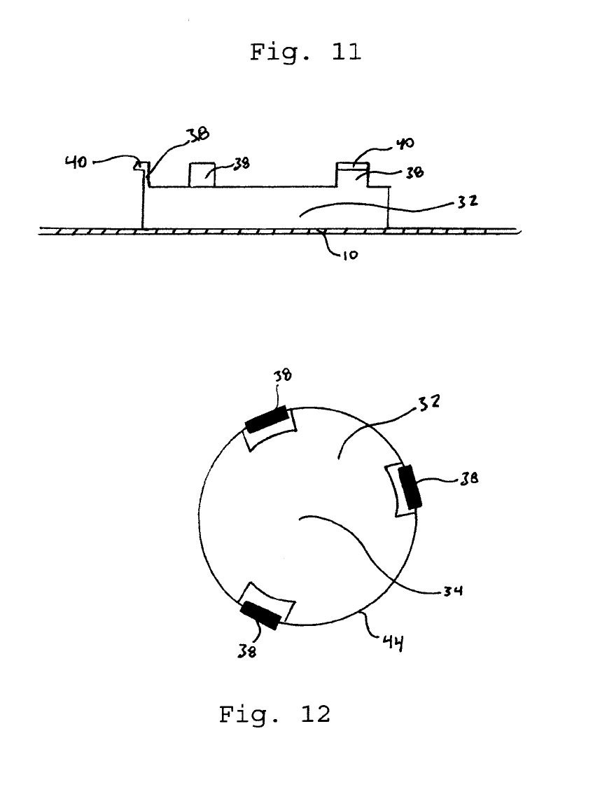

FIGS. 11-12 depict the elevated mount 32 with locking tabs 38 located on the top outer edge 44 of the elevated mount 32 and the locking tabs 38 having a protruded lip 40 on their upper surface. FIG. 12 shows that the locking tabs 38 extend outside the perimeter of the top outer edge 44 of the elevated mount 32.

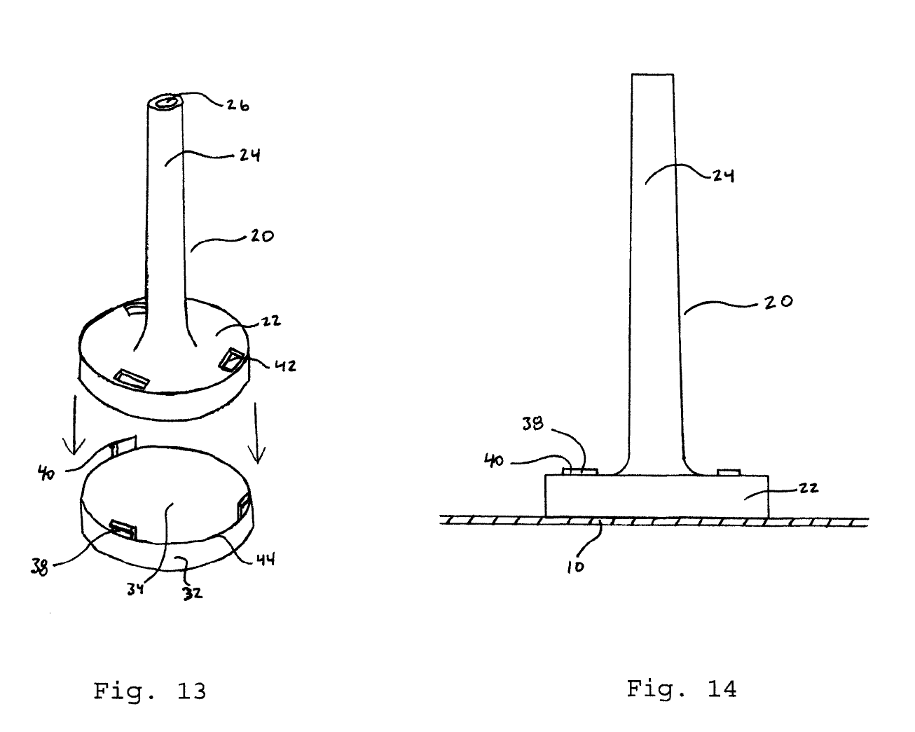

FIGS. 13-14 show the installation of the plant support holder 20 onto the elevated mount 32 and the locking tabs 38 connection through the slots 42 and the protruded lip 40 locking the plant support holder 20 onto the elevated mount 32. The locking tabs 38 flex when they are made to pass through the slots 42 and as soon as the protruded lip 40 of each locking tab 38 clears the slot 42 they return to their initial position thereby placing the protruding lip 40 on top of the base portion 22 and locking the elevated mount 32 to the plant support holder 20 thereby preventing accidental disengagement.

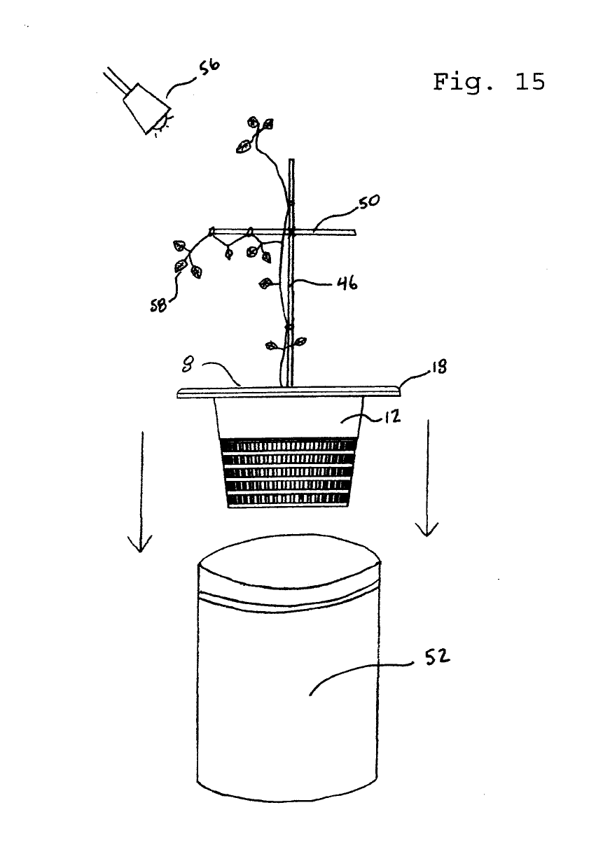

FIG. 15 shows the hydroponic growing pot 8 being installed into a reservoir 52 such that the hydroponic growing pot 8 by way of its rim 18 comes to rest on top of the reservoir 52 and is suspended into the nutrient solution. A central plant support 46 is installed into the hollow channel 26 of the plant support holder 20 having a horizontal plant support 50 attached to the central plant support 46 and plant 58 attached to both the central plant support 46 and the horizontal plant support 50. The central plant support 46 rests on the substantially solid central top surface 34 of the elevated mount 32 and nests within the taper 30 of the hollow channel 26. The reservoir 52 should be filled with an appropriate amount of water and nutrients and a light 56 should be directed at the plant 58. The hydroponic growing pot 8 should be lifted by its rim 18 for moving onto and out of the reservoir 52.

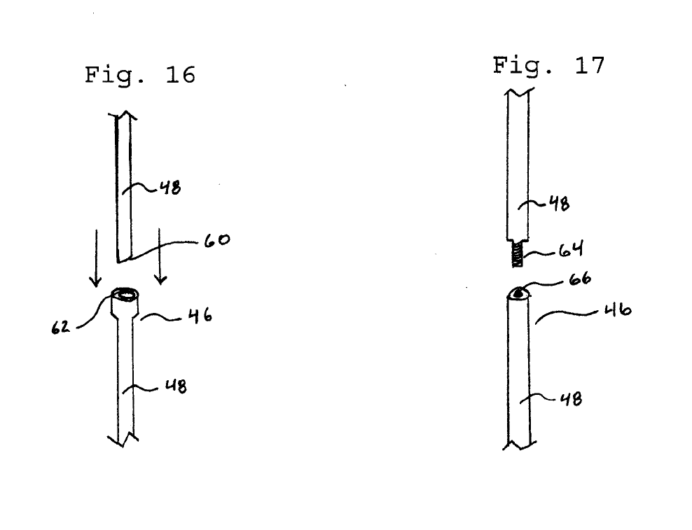

FIGS. 16-17 depict the central plant support 46 as separable plant support segments 48 to be used to achieve varying heights of support. The plant support segments 48 may be joined together by having a male ferrule 60 on end of a plant support segment 48 and female ferrule 62 on the opposite end of the plant support segment 48. This allows a user to attach as many plant support segments 48 as needed to create the central plant support 46 of desired height. In an alternate embodiment, FIG. 17 teaches the use of a plant support segment 48 with a male thread 64 on end of a plant support segment 48 and a female thread 66 on the opposite end of the plant support segment 48 thereby allowing the connection of as many plant support segments 48 as a user desires. The central plant support 46, plant support segments 48 and horizontal plant support 50 can be made of wood, plastic, metal, fiberglass, graphite and other similar rigid and lightweight materials.

While a preferred embodiment of the invention has been described using specific terms, such description is for illustrative purposes only, and it is to be understood that changes and variations may be made without departing from the spirit or scope of the following claims.

What is claimed is:

1. A hydroponic growing pot, comprising:
A bottom;
A sidewall that is joined to said bottom;
A top edge of said sidewall;
A plurality of apertures located formed through said bottom and said sidewall;
A rim attached to the top edge of said sidewall;
A plant support holder with a base portion, a stalk portion and a hollow channel running through said plant support holder from the bottom underside of the base portion up through the stalk portion;
Said plant support holder adapted to be attached in a fixed position onto said bottom of said growing pot, the upper surface of said bottom of the growing pot adapted to receive said base portion of said plant support holder, said base portion of said plant support holder adapted to be installed upon said bottom, and said plant support holder removable or installable at a user's discretion; and
Means for rigid attachment of said plant support holder to said elevated mount.

2. The apparatus of claim 1, wherein the hollow channel of said plant support holder is tapered.

3. The apparatus of claim 2, wherein a central plant support is installed within the plant support holder.

4. The apparatus of claim 3, wherein the central plant support is formed of more than one plant support segment with each said plant support segment provided with means for attachment to another said plant support segment.

5. The apparatus of claim 4, wherein one or more horizontal plant supports is attached to the central plant support at a point perpendicular to the central plant support.

6. A hydroponic growing pot, comprising:
A bottom;
A sidewall that is joined to said bottom;
A top edge of said sidewall;
A plurality of apertures located formed through said bottom and said sidewall;
A rim attached to the top edge of said sidewall;
A plant support holder with a base portion, a stalk portion and a hollow channel running through said plant support holder from the bottom underside of the base portion up through the stalk portion, said hollow channel having a taper;
Said plant support holder base portion having a plurality of slots adapted to receive locking tabs;
An elevated mount located on the upper surface of the bottom of the hydroponic growing pot adapted to nest into the bottom underside of the plant support holder base portion, said elevated mount having a substantially solid central top surface;
A plurality of locking tabs formed into a top outer edge of said elevated mount; and
Said locking tabs having a protruded lip on their upper surface.

7. The apparatus of claim 6, wherein a central plant support is installed within the plant support holder.

8. The apparatus of claim 7, wherein the central plant support is formed of more than one plant support segment with each said plant support segment provided with means for attachment to another said plant support segment.

9. The apparatus of claim 8, wherein one or more horizontal plant supports is attached to the central plant support at a point perpendicular to the central plant support.

10. A method for hydroponically growing a plant that provides stability to the plant and allows for the plant to be moved during its growth cycle without damage to the plant comprising the steps of:
Providing a hydroponic growing pot that is adapted to fit into a liquid holding reservoir with a bottom, a sidewall, a top edge of said sidewall, a plurality of apertures formed through said bottom and said sidewall, a rim attached to the top edge of said sidewall, a removable and rigid integrated plant support holder with a base portion, a stalk portion and a hollow channel running through said plant support holder from the bottom underside of the base portion up through the stalk portion, said hollow channel having a taper, said plant support holder that is adapted to be attached in a fixed position onto an elevated mount located on the upper surface of the bottom of the hydroponic pot, said elevated mount adapted to fit into an underside of said plant support holder, said elevated mount having a substantially solid central top surface, means for rigid attachment of said plant support holder onto said elevated mount;
Installing said plant support holder onto said elevated mount;
Inserting a substrate growing medium into said hydroponic growing pot;
Filling said liquid holding reservoir with an appropriate amount of liquid;
Placing said hydroponic growing pot into said liquid holding reservoir
Planting a plant into said substrate growing medium;
Providing a light source to said plant;
Inserting a central plant support into said plant support holder coming to rest upon a solid surface;
Attaching said plant to said central plant support as needed; and
Removing said hydroponic growing pot from said liquid holding reservoir to allow a user to change the liquid in the liquid holding reservoir or to place the hydroponic growing pot into a different liquid holding reservoir.

11. The method of claim 10, further comprising the step of extending the length of the central plant support by the attachment of additional plant support segments to said central plant support.

12. The method of claim 10, further comprising the steps of:
Attaching one or more horizontal plants supports perpendicular to said central plant support; and
Securing said plant to said horizontal supports as needed.

13. The method of claim 10, further comprising the steps of:
Extending the length of the central plant support by attachment of additional plant support segments;
Attaching one or more horizontal plant supports perpendicular to said central plant support; and
Securing said plant to said horizontal plant supports as needed.

14. The method of claim 13, further comprising the step of planting more than one plant in said substrate growing medium in said hydroponic growing pot.

15. The method of claim 14, further comprising the step of attaching more than one plant to said central plant support and horizontal plant support.
